(19) United States
(12) Patent Application Publication
(10) Pub. No.: US 2015/0160078 A1
(43) Pub. Date: Jun. 11, 2015

(54) METHOD FOR DIAGNOSING A SYSTEM FOR STORING A GAS STORED BY SORPTION ON A COMPOUND

(71) Applicant: Inergy Automotive Systems Research (Societe Anonyme), Bruxelles (BE)

(72) Inventors: Jules-Joseph Van Schaftingen, Wavre (BE); Francois Dougnier, Boortmeerbeek (BE); Dominique Madoux, Rumes (BE); Jean-Claude Habumuremyi, Haaltert (BE)

(73) Assignee: Inergy Automotive Systems Research (Societe Anonyme), Bruxelles (BE)

(21) Appl. No.: 14/411,659

(22) PCT Filed: Jun. 28, 2013
(86) PCT No.: PCT/FR2013/051521

§ 371 Date: Dec. 29, 2014

(30) Foreign Application Priority Data
Jun. 29, 2012 (FR) 1256289

(51) Int. Cl. G01K 17/06; G01M 15/10

(52) U.S. Cl. CPC G01K 17/06; G01M 15/102

(57) ABSTRACT

A method for diagnosing a system for storing a gas, the gas being stored by sorption on a compound, the system being mounted onboard a vehicle and including a tank configured to contain the compound and a control device configured to control a heating device to increase a temperature of the compound to release the gas. The control device obtains a set of information including at least one measurement of the temperature of the system, then carries out an estimation of the gas pressure in the system by using a predetermined kinetic model of desorption of the gas.

### FIELD OF THE INVENTION

The invention relates to a method for diagnosing a gas storage system, preferably mounted on board a motor vehicle.

The invention applies in particular, but not exclusively, to diagnosing an ammonia storage system.

The invention applies also, but not exclusively, to diagnosing a hydrogen storage system.

In the remainder of this document, every effort will be made to describe the particular case of an ammonia storage system comprising plastic storage components. The ammonia is, for example, intended to be injected into the exhaust line on a vehicle in order to reduce the amount of nitrogen oxides (NOx) in the exhaust gases. Naturally, the present invention applies to any other type of gas storage system mounted on board a vehicle and for which it is desired to obtain the pressure of the gas in the system and/or to diagnose the operating state of such a system. More generally, the invention applies to any type of gas (ammonia, hydrogen, etc.) that can be stored by sorption on a compound.

### TECHNOLOGICAL BACKGROUND

The nitrogen oxides present in the exhaust gases of vehicles, in particular diesel vehicles, can be eliminated via the technique of selective catalytic reduction (generally referred to as SCR). According to this technique, doses of ammonia (NH₃) are injected into the exhaust line upstream of a catalyst on which the reduction reactions take place. Currently, the ammonia is produced by the thermal decomposition of a precursor, generally an aqueous solution of urea. On-board systems for storing, dispensing and metering out a solution of standardized urea (such as that sold under the name Adblue®, a eutectic solution containing 32.5% urea in water) have thus been put on the market.

Another technique consists in storing the ammonia by sorption on a salt, usually an alkaline-earth metal chloride. Generally in this case, the storage system comprises a reservoir designed to contain the salt and a heating device configured in order to heat the salt. Thus, by heating the salt the ammonia is released. A pressure of ammonia is therefore generated. In such an ammonia storage system it is sought to obtain the pressure of ammonia released in order, for example, to verify that it corresponds to a required pressure of ammonia and, where appropriate, carry out corrective actions. It is also sought to detect the overheating of the salt heating device. This is even more important if the reservoir (formed by one or more storage components) is made of plastic, the mechanical properties of which are relatively temperature-sensitive. Generally, a pressure sensor or a pressure regulator is used to measure the pressure of ammonia released. These pressure sensors and regulators are expensive and bulky (compared to a temperature sensor). Generally, in order to detect the overheating of the salt heating device, the system uses a temperature sensor. Thus, the overheating is detected in a simple and effective manner. However, in certain cases it is desirable to be able to have other diagnostic information available, in particular to guarantee safe operation of the storage system and an effective reduction of the nitrogen oxides in the exhaust gases.

### OBJECTIVES OF THE INVENTION

It is therefore desirable to provide a technique for diagnosing a gas storage system that makes it possible to obtain the pressure of the gas in the system without using a pressure sensor or pressure regulator.

It is also desirable to obtain a number of items of information relating to the operation of the gas storage system.

It is also desirable to provide such a technique that is simple to implement, whatever gases and compounds are used.

### SUMMARY OF THE INVENTION

In one particular embodiment of the invention, a method is proposed for diagnosing a system for storing a gas, the gas being stored by sorption on a compound, the system being mounted on board a vehicle and comprising a reservoir capable of containing the compound and a control device suitable for controlling a heating device in order to raise the temperature of the compound so as to release the gas. The control device is such that it obtains a set of information comprising at least one temperature measurement of the system, then estimates the pressure of the gas in the system using a predetermined model of the gas desorption kinetics.

Thus, the present invention proposes to use one or more temperature measurements of the storage system in order to deduce therefrom the pressure of the gas in the system. The temperature measurement(s) is (are) obtained by means of one or more temperature sensors already present in the storage system. In one particular embodiment, the set of information that is used to estimate the pressure within the storage system comprises one or more temperature measurements carried out at a common instant (i.e. instantaneous measurements) and a history of temperature measurements, that is to say a set of temperature measurements carried out at instants preceding the common instant. In one embodiment variant, the set of information may comprise a functional of the history of these measurements. For example, such a functional (function of the function) may be an integral of the type:

Functional 1(t)=integral of (t−t1) at t of f(τ) T1(τ) dτ

with for example f(τ)=A*τ+B

where t denotes the time, T1 is the temperature measurement, t1, A and B are constants, and τ represents a time variable.

Usually, the desorption kinetics model for a given gas stored by sorption on a given compound is known. If this model is not known, it is possible to obtain it in a simple manner, for example, by measuring the desorption curve of the gas during the operation of the heating device. Using the desorption kinetics model it is possible to particularly accurately approach the pressure that actually exists within the storage system at the instant of the temperature measurement. The method according to invention thus makes it possible to very accurately calculate the pressure of the gas in the system, without using a pressure sensor or pressure regulator, which leads to a significant improvement in the assembly of the storage system and in the reduction of the cost of such a system.

In one preferred embodiment, the control device is on-board the vehicle, for example in the form of a microprocessor. In another embodiment, the control device is, for example, a computer (or server) located outside of the vehicle, for example in a laboratory. Indeed, before being definitively mounted on the destination vehicle, the storage system may, for example, during a test phase, be mounted on a test bench. For example, during this test phase, the computer (playing the role of control device) may adjust the desorption kinetics model of the gas to be used.

The desorption kinetics model of the gas is, for example, stored in a memory accessible to (i.e. readable by) the control device.

The gas may be of any type, preferably ammonia or hydrogen.

Advantageously, the control device is configured in order to determine operating conditions of the system from the set of information, and to select the model used from among a number of predetermined models of the gas desorption kinetics, as a function of the operating conditions determined.

In order to estimate the pressure of the gas in the system as accurately as possible, it is important to know under what conditions the system operates. This is because the operating conditions of the system have an influence on the desorption of the gas. This is why, according to one preferred embodiment of the invention, the control device chooses the gas desorption kinetics model that is most compatible with the operating conditions of the system. The various gas desorption kinetics models are, for example, stored in a memory accessible to (i.e. readable by) the control device. In one particular embodiment, the set of information comprises, in addition to the temperature measurement(s), an item of information (or a history) relating to the power dissipated by the heating device, an item of information (or a history) relating to the atmospheric pressure, or else an item of information (or a history) relating to the ambient temperature outside of the vehicle. This set of information is, for example, stored in a memory accessible to (i.e. readable by) the control device.

Advantageously, the model used is a Clausius-Clapeyron relation. The model used is a pressure/temperature relation governing the sorption of the gas on the compound. The Clausius-Clapeyron relation used in the method according to invention may be a theoretical relation (curve, table, formula, etc.), derived from the literature, preferably validated experimentally. Alternatively, this relation may be generated experimentally on models and/or prototypes.

Advantageously, the control device is configured in order to detect at least one item of information regarding the operating state of the system using the set of information and at least one of the following models:
a predetermined model of operation of the reservoir;
a predetermined model of operation of the heating device.

Usually, the operating model of a given reservoir and the operating model of a given heating device are known. These models are, for example, theoretical curves, mappings or envelopes obtained experimentally for various operating states representative both of the operation of the reservoir and of the heating device. In one preferred embodiment, all or some of the information from the set of information is compared with predefined threshold ranges in order to diagnose the operating state of the storage system.

The information regarding the operating state of the system may for example be a detection of the absence of temperature rise with respect to a high heating power setpoint. The information regarding the operating state of the system may for example be a detection of an abnormally high temperature, that is to say a temperature that may prove to be too critical for the long-term integrity of the reservoir. Information regarding the operating state of the system may for example be a gas fill level of the reservoir. Advantageously, a list of the various operating states possible is previously established and stored in a memory accessible to (i.e. readable by) the control device.

According to one advantageous feature, said reservoir comprises a storage cell equipped with at least one of the following sensors:
a temperature sensor;
a heat flux sensor.

The sensor(s) may be mounted on the inside or outside (for example on the wall) of the cell. Some sensors may be mounted on the inside of the cell and other sensors outside of the cell. The sensors are spread over and/or in the cell as a function in particular of the geometry of the cell and of the diagnostic information that it is desired to obtain.

Advantageously, the storage cell comprises a wall wherein at least one housing is formed, each housing extending toward the inside of the cell and being configured in order to receive the sensor(s).

The mounting of the sensor(s) in the cell is therefore simple. Indeed, it is sufficient to insert it or them in the housing(s) provided for this purpose. Advantageously, one and the same housing may contain one or more sensors.

In one preferred embodiment, the cell is made of plastic.

Advantageously, the cell is covered with at least one of the following materials:
a thermally insulating material;
a phase change material.

Advantageously, the cell is covered with an additional heating device.

Advantageously, the cell comprises a network of heat conductors.

Advantageously, the reservoir comprises at least one other storage cell. Thus, the reservoir may be constituted of a group of cells.

The method according to invention is particularly well suited to the case where the reservoir comprises a compound, preferably a solid, to which a gas (ammonia, hydrogen, etc.) is attached via sorption, preferably via chemisorption. It is generally an alkali, alkaline-earth or transition metal chloride. It may be in the pulverulent state or in the form of agglomerates. This compound is preferably an alkaline-earth metal chloride, and very particularly preferably an Mg, Ba or Sr chloride.

### LIST OF FIGURES

Other features and advantages of the invention will appear on reading the following description, given by way of indicative and nonlimiting example, and the appended drawings, in which:

FIG. 1 illustrates the structural architecture of an SCR system comprising a gas storage system, according to one particular embodiment of the invention;

FIG. 2 presents one particular embodiment of a diagnostic algorithm for the gas storage system of FIG. 1;

FIGS. 3 to 17 illustrate examples of cells included in the gas storage system of FIG. 1.

### DETAILED DESCRIPTION

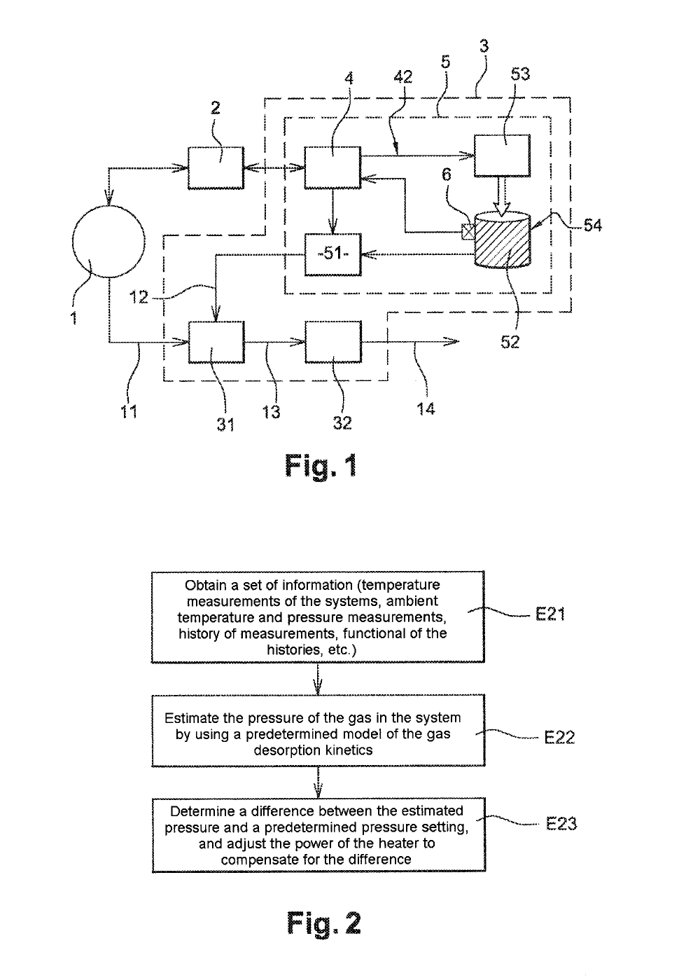

Exemplary embodiments are described below in relation to FIGS. 1 to 17 where the gas stored by sorption on the compound is ammonia. Of course, in one embodiment variant, the gas may be of any other type, and in particular hydrogen.

As illustrated in FIG. 1, the engine 1 of the vehicle is controlled by an engine control unit 2 (ECU). The engine 1 cooperates with an SCR system 3. On leaving the engine, the exhaust gases 11 are directed toward an ammonia injection module 31, in which the ammonia 12 is mixed with the exhaust gases 11. The ammonia/exhaust gases mixture 13 then passes over an SCR catalyst 32 which enables the reduction of the nitrogen oxides (NOx) by the ammonia. The decontaminated exhaust gases 14 are then directed toward the exhaust outlet.

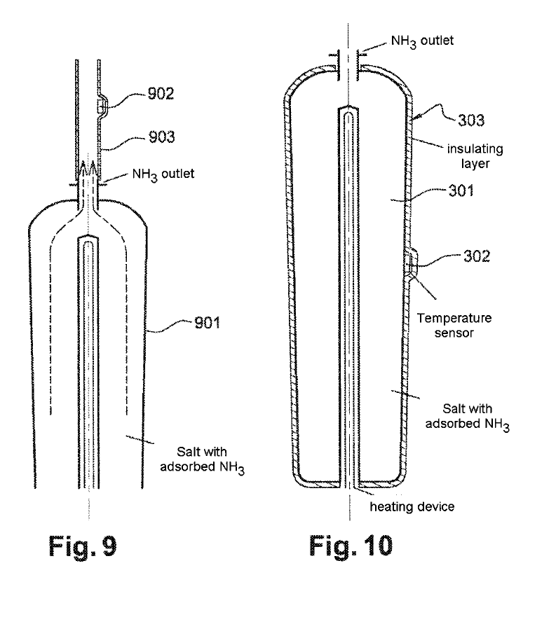

In this exemplary embodiment, the SCR system 3 comprises an ammonia storage system 5. The storage system 5 comprises a reservoir 54, stored in which is a compound 52, for example a solid (and preferably a salt). The ammonia is stored by sorption on the solid 52. The storage system 5 also comprises a control device 4 in charge of controlling a heating device 53 (also referred to as heater) for heating the solid 52 so as to release the ammonia. The heating device 53 may be in the form of an electrical resistor. The reservoir 54 is connected to a dosing module 51 via a distribution duct (referenced 903 in FIG. 9). The dosing module 51 is controlled by the control device 4. In the exemplary embodiment illustrated in FIG. 1, the control device 4 is a different from the engine control unit 2. In one embodiment variant, the control device 4 may be integrated into the engine control unit 2. In another embodiment variant, the control device 4 may be integrated into the fuel system control unit (FSCU). The control device 4 according to invention is capable of estimating the pressure of ammonia in the storage system 5. If a difference is observed between the estimated pressure and a pressure setting supplied by the engine control unit 2, the control device 4 may adjust the heating power of the heating device 53 in order to compensate for this difference. As illustrated in FIG. 1, the reservoir 54 is equipped with a temperature measuring device 6.

One particular embodiment of a diagnostic algorithm, as implemented within the control device 4, is now described in relation to FIGS. 1 and 2.

During a step E21, the control device 4 obtains a set of information.

In one particular embodiment, the temperature measuring device 6 may comprise a temperature sensor configured in order to measure the temperature at a given point of the reservoir. Thus, in step E21 the control device 4 may receive an instantaneous temperature measurement originating from the temperature sensor.

In one embodiment variant, the temperature measuring device 6 may comprise a plurality of temperature sensors positioned at several points of the reservoir. Thus, in this variant, in step E21 the control device 4 receives a set of temperature measurements.

In another embodiment variant, in step E21 the control device 4 reads (and in this sense obtains) a history of temperature measurements stored, for example, in a memory.

Advantageously, in step E21 the control device 4 may also obtain information on the ambient temperature and pressure. These may be instantaneous temperature and pressure measurements, histories of these measurements, functionals (function of function) or a combination of these measurement histories. Thus, for example, the control device 4 may obtain the average temperature measured on a sensor over the previous five minutes; or else an average temperature calculated by weighting the recent instants more than the instants further back in time. From such information, the control device 4 may determine the operating conditions under which the storage system will change.

In one particular embodiment, the control device 4 is capable of using a predetermined model of the gas desorption kinetics. This mathematical or experimental model may be, for example, stored in a memory.

In one embodiment variant, the control device 4 is capable of generating several models of the gas desorption kinetics. Indeed, the desorption kinetics of a given gas may vary as a function of environmental parameters such as, for example, the ambient pressure and temperature, the moisture content, or else the ageing of the reservoir. The desorption kinetics may also depend on the degree of gas loading of the system. For example, each model may be associated with an ambient pressure/temperature pairing. Thus, in an optional step (not represented) the control device 4 may select from among the various predetermined models for the gas desorption kinetics the one which is associated with the ambient temperature and pressure measurements obtained in the preceding step E21. In this way, having the best estimate of pressure of the gas in the system is always guaranteed.

In another optional step (not represented), the control device 4 may use the set of information obtained in the preceding step E21 (instantaneous measurements, histories, functionals, etc.) in combination with predetermined models of operation of the reservoir 54 and of the heating device 53 in order to verify the plausibility and criticality of the parameters measured, and also the operating state of the system. For example, the control device 4 may detect a possible component (reservoir, heater, etc.) malfunction or a possible risk, for example an abnormally high temperature that may degrade the integrity of the reservoir.

Next, during step E22, the control device 4 estimates the pressure of the gas in the system on the basis of the set of information obtained and a predetermined (or preselected) model of the gas desorption kinetics. Then, this pressure estimate may be stored in a memory, so as to be able to constitute a history of the pressure estimates.

In one particular embodiment, the model is a curve linking the pressure of the gas to the temperature of the compound. For example, such a curve may be deduced from the Clausius-Clapeyron relation.

In one embodiment variant, the model comprises a table linking a functional value to a pressure value. For example, this functional value may be obtained by calculating an integral function from all of the instantaneous measurements obtained in step E21.

Finally, by way of example, during a step E23, the control device 4 makes it possible to determine the difference between the estimated pressure and a pressure setting provided, for example, by the engine control unit 2, and where appropriate to adjust the heating power of the heating device 53 in order to compensate for this difference. For example, if the pressure estimated by the control device 4 is greater than the pressure setting, then the control device 4 generates a signal 42 such that it decreases the supply power of the heating device 53.

In one preferred embodiment, the reservoir 54 comprises a plurality of storage cells that communicate with one another and with at least one orifice that communicates with the dosing module 51, via a distribution duct (referenced 903 in FIG. 9). Such a reservoir is, for example, described in the co-pending application EP 11183413.1 in the name of the applicant, the content of which is for this purpose incorporated by reference into the present application.

The term “reservoir” is understood to denote a container or chamber that delimits at least one internal volume used to contain the compound. Preferably, the reservoir comprises at least one wall that delimits cells, i.e. cavities capable of containing said compound. These cavities may have any shape. Preferably, they all have the same shape. The shape and size of the cells are preferably suitable for being able to match at least one part of the outer surface of the agglomerates.

Preferably, the cells are made of plastic. Thermoplastics give good results within the context the invention, in particular due to advantages of weight, of mechanical strength and chemical resistance and of easier processing (which precisely makes it possible to obtain complex shapes).

In particular, it is possible to use polyolefins, polyvinyl halides, thermoplastic polyesters, polyketones, polyamides, polyphthalamides and copolymers thereof. A blend of polymers or copolymers may also be used, as can a blend of polymeric materials with inorganic, organic and/or natural fillers such as, for example, but nonlimitingly: carbon, salts and other inorganic derivatives, natural fibers, glass fibers and polymeric fibers. It is also possible to use multilayer structures consisting of stacked layers that are firmly attached comprising at least one of the polymers or copolymers described above.

Excellent results have been obtained with polyphthalamide filled with glass fibers.

Preferably, the shape of the cells (all or some of them) and/or their method of production and/or assembly is such that at least one active component of the system (fulfilling a useful function such as heating, cooling or mechanical reinforcement) can be inserted in or between them. For example, a heating component or a phase change material (PCM, or material that stores or releases heat on changing phase depending on the temperature that surrounds it) is advantageously inserted in or between the cells.

The use of heating components or phase change materials makes it possible to stabilize the temperature of the reactant contained in the cell and to thus ensure a stable production of gas. Furthermore, the use of differentiated heating between cells and/or different relative amounts of phase change materials between cells makes it possible to deplete or enrich certain cells in terms of gas; for example, during a shutdown of the system (following for example stopping of the vehicle), the gas (for example ammonia) loading in the cells that cool more quickly (for example containing little or no phase change material) will increase at the expense of the cells that cool more slowly (for example containing a lot of phase change material). This may be particularly advantageous for ensuring a rapid provision of the gas after the vehicle has been stopped, for example by activating at this moment preferably the gas-rich cells.

In the variant of the invention according to which the reservoir comprises several cells, the use of one temperature sensor per cell or group of cells makes it possible to control each cell or group of cells independently in terms of temperature and therefore pressure. This temperature control of the various cells or group of cells makes it possible to ensure a transfer of gas from one cell or from one group of cells to another cell or another group of cells.

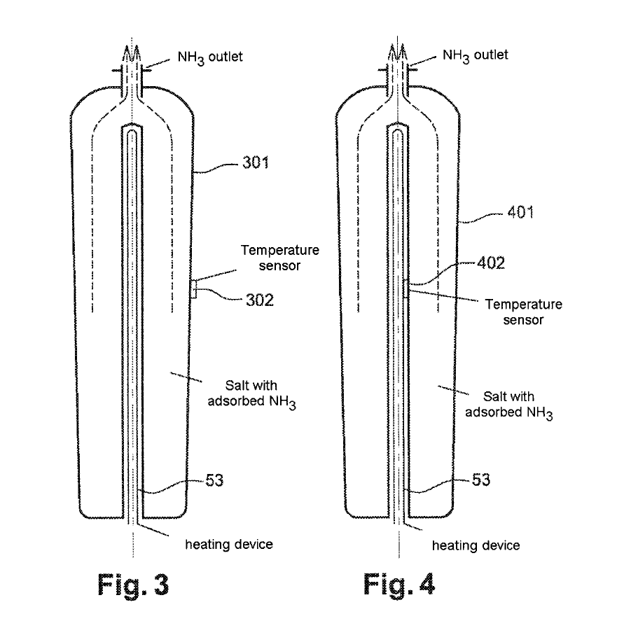

FIGS. 3 to 17 schematically illustrate examples of cells each equipped with a temperature measurement device according to one particular embodiment of the invention.

FIG. 3 illustrates a configuration in which the heating device 53 is placed in a housing, referred to subsequently as a heating shaft, located at the center of the cell 301. In the example from FIG. 3, the temperature measurement device according to invention comprises a single temperature sensor 302. The temperature sensor 302 is mounted on the outer wall of the cell 301. The temperature sensor may be mounted by any conventional mechanical means. In particular, clip fastening or adhesive bonding to the wall is particularly suitable for a plastic cell. In this case, when the heater 53 is activated with a view to desorbing the gas (for example, ammonia, hydrogen, etc.) (stored by sorption on a compound), an increase in temperature is observed after a certain period of time. According to one advantageous aspect of the invention, the fact of observing this increase in temperature makes it possible to ensure the plausibility of the signal from the sensor 302 and the correct operation of the heater 53. The plausibility of the signal from the sensor 302 and the correct operation of the heater 53 are determined using a predetermined model of operation of the sensor and a predetermined model of operation of the heater 53.

According to another advantageous aspect of the invention, the control device permanently monitors the reaching of a predetermined temperature threshold (i.e. predetermined model of operation of the reservoir, it being possible for this model to comprise several predetermined temperature thresholds or ranges). If the control device detects that the temperature measured is greater than this temperature threshold, then it turns off the heating. Any overheating of the SCR system is thus avoided. According to another advantageous aspect of the invention, by analyzing the change in temperature as a function of time, it is possible to estimate the gas content of the compound (for example a salt) separating the heater 53 from the temperature sensor 302. Specifically, the gas content affects the heat transfer within the compound, in particular since the desorption of the gas is endothermic, a high content of gas in the compound tends to slow down the temperature rise at the sensor 302. When the gas consumption is stable, the signal from the sensor 302 makes it possible to regulate the heating so as to stabilize the pressure; an increase in the gas consumption results in a temperature drop which may be compensated for by appropriate action of the control device on the heater 53; conversely, a reduction in consumption results in a temperature increase which may also be compensated for. In one embodiment variant, the temperature sensor 302 may be replaced by a heat flux sensor.

FIG. 4 illustrates a configuration in which a temperature sensor 402 is mounted on the outer wall of the cell 401 and in the vicinity of the heating shaft. This arrangement is particularly advantageous for detecting any risk of overheating of the shaft level with the heating component. One particularly advantageous case is constituted by a temperature sensor 402 that at the same time acts as a PTC (Positive Thermal Coefficient) heater, the resistance of which increases with the temperature thus providing both the measurement and the heating function. These PTC heaters also offer the advantage of limiting the heating power as the temperature rises, which reduces the risk of overheating.

In one advantageous variant (not illustrated), it is proposed to use a heating device that itself has a PTC characteristic. In this way, it is possible to provide both the heating of the cell and the temperature measurement.

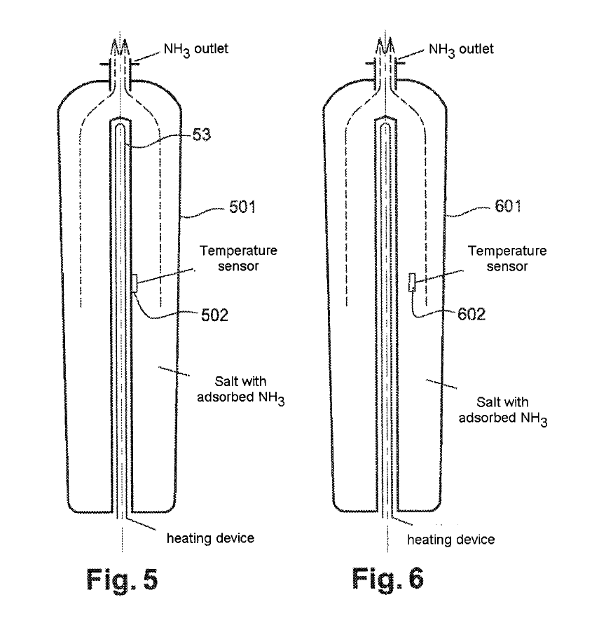

FIG. 5 illustrates a configuration in which a temperature sensor 502 is mounted on the inner wall of the cell 501 and in the vicinity of the heating shaft.

The configurations from FIGS. 4 and 5 have the advantage of enabling a rapid detection of risks of overheating. The safety of the SCR system is therefore improved.

FIG. 6 illustrates a configuration in which a temperature sensor 602 extends inside the cell 601. This configuration has the advantage of enabling a more accurate measurement of the temperature of the compound, and therefore of obtaining a more accurate estimate of released pressure. The sensor may be for example directly placed in the compound when it is placed in the cell.

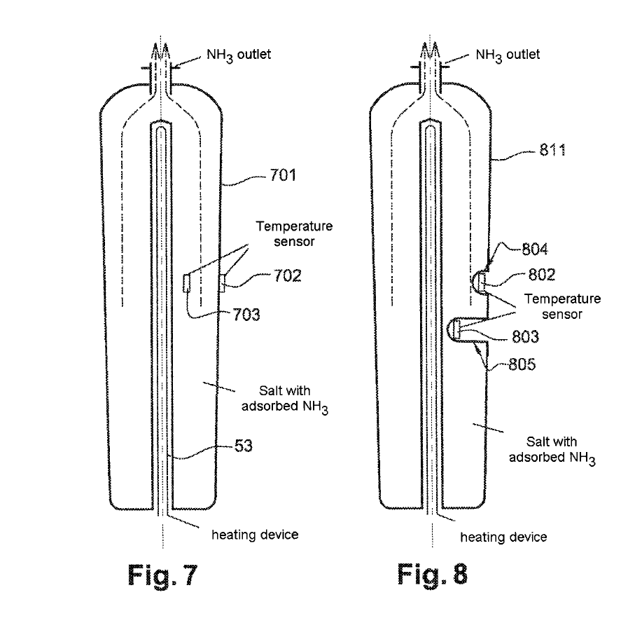

FIG. 7 illustrates a configuration in which the temperature measurement device according to invention comprises two temperature sensors 702 and 703. The temperature sensor 702 is mounted on the outer wall of the cell 701 and the temperature sensor 703 extends inside the cell 701.

FIG. 8 illustrates a configuration in which the cell 801 comprises two housings 804 and 805 (or transverse shafts) formed in its wall. The housings 804 and 805 extend toward the heating shaft so as to plunge into the compound. In this example, the temperature measurement device according to invention comprises two temperature sensors 802 and 803. The housing 804 is configured to receive the temperature sensor 802, and the housing 805 is configured to receive the temperature sensor 803.

The configurations from FIGS. 7 and 8 each use a combination of two temperature sensors. The combined use of two temperature sensors advantageously enables the control device to obtain temperature measurements from which it is possible to estimate a heat flux. Such a heat flux, if it is measured at precise points (for example at the periphery of the cell) makes it possible to evaluate the energy consumption. In one embodiment variant, one of the two temperature sensors may be replaced by a heat flux sensor.

As illustrated in the example from FIG. 9, the temperature measurement device according to invention may comprise a temperature sensor 902 mounted in the distribution duct 903 that connects the cell 901 to the dosing module (referenced 51 in FIG. 1).

FIG. 10 illustrates an embodiment variant of the configuration described above in connection with FIG. 3. In this variant, almost all of the outer wall of the cell 301 and the temperature sensor 302 (which is mounted on the outer wall of the cell) are covered with a layer 303 of thermally insulating material. For example, sheets of Neoprene material give good results. The use of this layer 303 of thermally insulating material advantageously makes it possible to avoid heat losses from the cells. This also makes it possible to reduce the disturbances on the temperature sensor 302, in particular the influence of the surroundings of the cells.

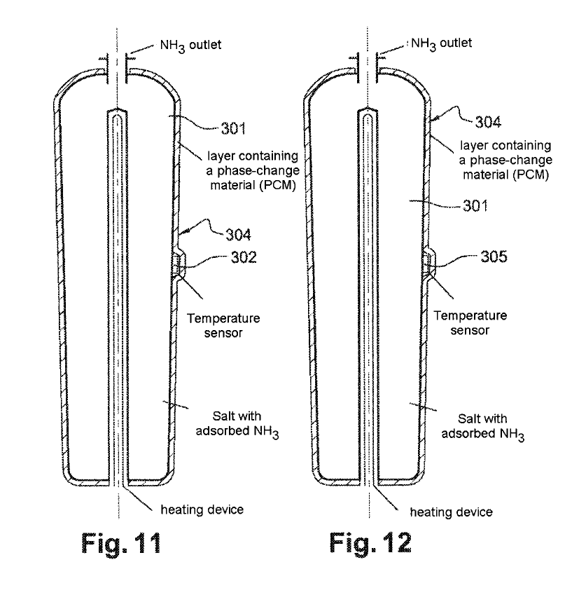

FIG. 11 illustrates another embodiment variant of the configuration described above in connection with FIG. 3. In this variant, almost all of the outer wall of the cell 301 and the temperature sensor 302 (which is mounted on the outer wall of the cell) are covered with a layer 304 of phase change material (PCM). In one preferred embodiment, the phase change temperature of the PCM material corresponds to the desorption temperature of the compound (i.e. salt) generating the pressure necessary for the exhaust of the vehicle (typically 2.8 bar absolute). The use of this layer 304 of PCM material advantageously makes it possible to stabilize the temperature of the compound, and the pressure of the gas, for example around the value desired for this pressure. In this variant, the temperature rise curve has a hold at the phase change temperature of the PCM, which makes it possible to easily diagnose reaching the desired temperature. Furthermore, in case of high gas consumption, the temperature of the compound tends to drop and the PCM material then restores heat to the cell, thus stabilizing the temperature and the pressure. In case of low consumption on the other hand, the PCM material stores heat.

Other embodiment variants may be imagined without departing from the scope of the present invention, for example by combining the components of the various embodiments described above in connection with FIGS. 3 to 11.

In particular, the cells from FIGS. 4 to 9 may each be covered with a layer of insulating material and/or with a layer of PCM material.

Furthermore, and as illustrated in FIG. 12, the temperature sensor 302 from FIG. 11 may be replaced by a heat flux sensor 305. In example of FIG. 12, the heat flux sensor 305 makes it possible to measure the flux between the layer 304 of PCM material and the cell 301 and thus to determine to what extent the control device must compensate for the energy losses.

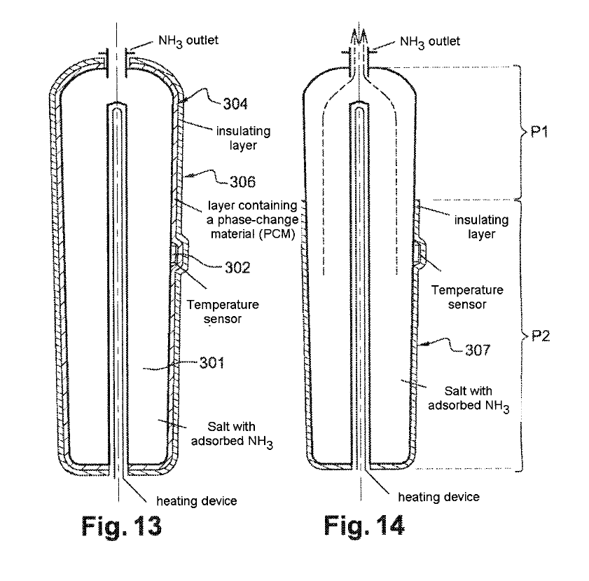

As is stated in FIG. 13, the layer 304 of PCM material from FIG. 11 may itself be covered with a layer 306 of thermally insulating material. This makes it possible to further improve the performances of the system due to the reduced effect of the surrounding conditions. It goes without saying that a variant with a flux sensor may also be envisaged.

In one embodiment variant of FIG. 13, the temperature sensor 302 may be placed between the layer 304 of PCM material and the layer 306 of insulating material.

FIG. 14 illustrates another embodiment variant of the configuration described above in connection with FIG. 3. In this variant, a first cell portion P1 is left bare (i.e. uninsulated) and a second cell portion P2 is covered with a layer 307 of thermally insulating material. Thus, such a configuration makes it possible, during the shutdown of the system, to cool the portion P1 more rapidly, and therefore to enable a transfer of gas from the portion P2 that is still hot to the portion P1 that is already colder.

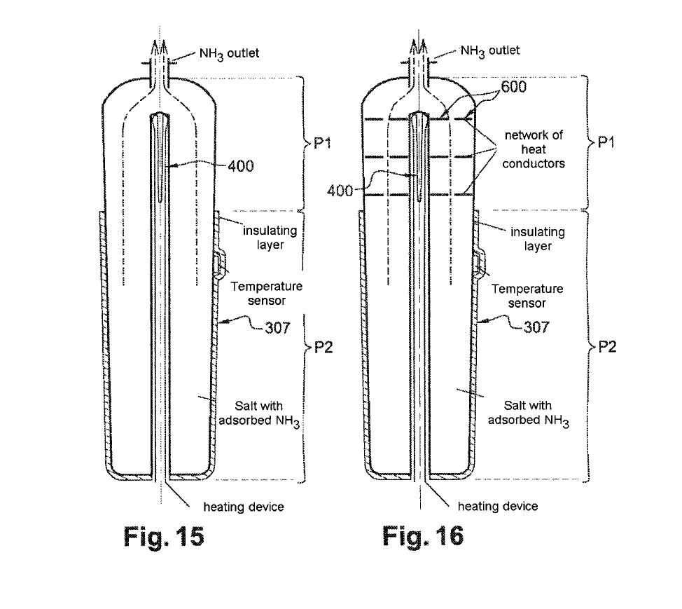

FIG. 15 illustrates an embodiment variant of the configuration described above in connection with FIG. 14. In this variant, a differential heating device 400 is placed in the heating shaft. Thus, in order to enable a rapid start-up, the heating power may be concentrated in the region containing the greatest concentration of gas at start-up, for example level with the uninsulated portion P1. This differential heating may for example be obtained simply by placing a heating wire in the heating shaft, for example in helical form and by varying the pitch of this helix (for example smaller pitch in the portion P1 to be heated rapidly).

FIG. 16 illustrates an embodiment variant of the configuration described above in connection with FIG. 15. In this variant, the cell comprises within it a network of heat conductors 600. This network of heat conductors 600 makes it possible to ensure a very rapid heat transfer in the region containing the greatest concentration of gas at start-up, for example level with the uninsulated portion P1. The heat conductors 600 are, for example, perforated discs or grates made of a good heat conductor. These heat conductors 600 are placed on or in the compound, so that they enable a rapid radial heat transfer between the heating channel (i.e. heating shaft) and the periphery of the cell level with the portion P1.

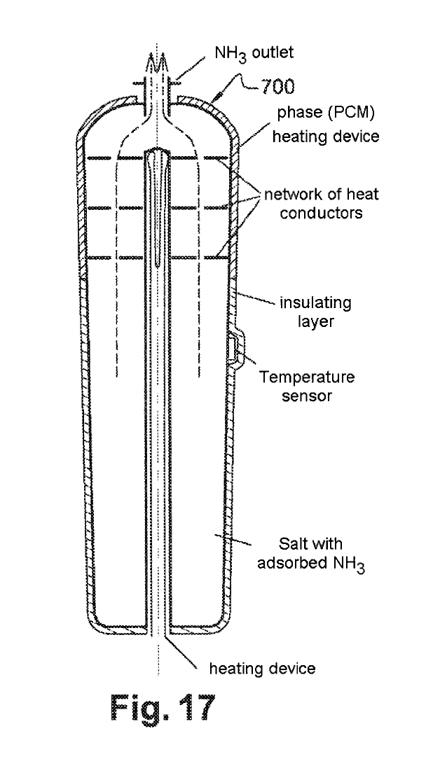

FIG. 17 illustrates an embodiment variant of the configuration described above in connection with FIG. 16. In this variant, the portion P1 of the cell is covered with an additional heating device 700. In this way, the heating is increased level with the portion P 1. In example from FIG. 17, the additional heating device 700 is mounted on the outer wall of the cell. Of course, in another embodiment, this additional heating device 700 may be mounted on the inside of the cell. The additional heating device 700 may or may not be controlled independently of the other heating device(s) of the cell.

It is noted that the differential system presented above in connection with FIGS. 15 to 17 may be used level with a group of cells, or even between a group of cells. This differential system may be optimized as a function of the temperature and heat transfer conditions that exist in the vehicle environment. For example, the uninsulated regions will be placed at locations that cool rapidly, whereas the insulated regions will be placed in locations that remain hot for longer during the shutdown of the vehicle.

In view of the description of FIGS. 1 to 17 above, the control device according to invention is capable of implementing various heating strategies, and in particular the following:
a heating strategy applied to cells as described above consisting in maintaining the heating in certain regions of the cells or in certain cells or in certain groups of cells so as to transfer the gas to the regions that cool more rapidly;
a heating strategy that generates, when the vehicle is running or during certain particular running phases during which the gas consumption is low, a transfer of gas to particular regions of the whole of the storage system, for example heating in certain groups of cells and stopping the heating in others;
a heating strategy that makes it possible to avoid the overheating of the heating shaft (made of plastic) and that consists, for example, in breaking up or modulating the heating power so as to enable the removal of thermal energy in the compound via conduction. A PWM signal, the periodicity of which is adapted to the characteristic time of the heat transfer corresponding to the geometry and properties of the materials, is particularly advantageous;
a heating strategy based on the gas loading state of the cells or portions of cells made of plastic. This gas loading state is derived from the relation between the signals from the temperature sensor(s) and time profile of the heating control(s) of these cells: since the desorption of the gas is endothermic, the heating pulses will result in little effect at the outer wall and at a temperature sensor placed close thereto if the compound (i.e. salt) is highly loaded;
a heating strategy based on a measurement of the heat flux level with the outer wall of the cells or group of cells or storage system or in the vicinity of this wall;
a heating strategy based on a measurement of the heat flux and of the temperature level with the outer wall of the cells or group of cells or storage system;
a heating strategy based on a measurement of the localized temperature in a pocket (or housing) hollowed out at any location of the wall of the cells or group of cells or storage system made of plastic and that gives access to the temperature of the compound at any location.

1-13. (canceled)

14. A method for diagnosing a system for storing a gas, the gas being stored by sorption on a compound, the system being mounted on board a vehicle and including a reservoir configured to contain the compound and a control device configured to control a heating device to raise a temperature of the compound to release the gas, the method comprising:
the control device obtaining a set of information including at least one temperature measurement of the system, the control device then estimating a pressure of the gas in the system using a predetermined model of gas desorption kinetics;
the reservoir including a storage cell including at least one of the following sensors:
a temperature sensor;
a heat flux sensor.

15. The method as claimed in claim 14, wherein the control device is configured to determine operating conditions of the system from the set of information, and to select the model used from among a number of predetermined models of the gas desorption kinetics, as a function of the operating conditions determined.

16. The method as claimed in claim 14, wherein the model used is a Clausius-Clapeyron relation.

17. The method as claimed in claim 14, wherein the control device is configured to detect at least one item of information regarding an operating state of the system using the set of information and at least one of the following models:
a predetermined model of operation of the reservoir;
a predetermined model of operation of the heating device.

18. The method as claimed in claim 14, wherein the storage cell comprises a wall wherein at least one housing is formed, each housing extending toward the inside of the cell and being configured to receive one of the sensors.

19. The method as claimed in claim 14, wherein the cell is made of plastic.

20. The method as claimed in claim 14, wherein the cell is covered with at least one of the following materials:
a thermally insulating material;
a phase change material.

21. The method as claimed in claim 14, wherein the cell is covered with an additional heating device.

22. The method as claimed in claim 14, wherein the cell comprises a network of heat conductors.

23. The method as claimed in claim 14, wherein the reservoir comprises at least one other storage cell.

24. The method as claimed in claim 14, wherein the compound is a solid.

25. The method as claimed in claim 14, wherein the gas is ammonia.

26. The method as claimed in claim 14, wherein the gas is hydrogen.
